(19) United States
(12) Patent Application Publication
(10) Pub. No.: US 2015/0120023 A1
(43) Pub. Date: Apr. 30, 2015

(54) ENTERTAINMENT CONTENT FITNESS GAMING SYSTEM

(71) Applicant: James Richard TERRELL, II, Charlotte, NC (US)

(72) Inventor: James Richard TERRELL, II, Charlotte, NC (US)

(21) Appl. No.: 14/526,470

(22) Filed: Oct. 28, 2014

Related U.S. Application Data
(60) Provisional application No. 61/896,186, filed on Oct. 28, 2013.

(51) Int. Cl. A63F 13/816; A63B 24/00

(52) U.S. Cl. CPC A63F 13/816; A63B 24/0062
USPC 700/91

(57) ABSTRACT

A method for correlating fitness workouts to entertainment content includes providing a workout game corresponding to entertainment content presented to a user, receiving information corresponding to an entertainment content segment viewed or otherwise consumed by the user, receiving information corresponding to physical activity of the user while consuming the entertainment content segment. The workout game includes a plurality of cues, and each cue of the plurality of cues corresponds to a workout move to be performed by the user. The method further includes identifying a plurality of events in the entertainment content segment, wherein each event of the plurality of events corresponds to a particular cue of the plurality of cues, and correlating the plurality of cues with the information corresponding to physical activity of the user while consuming the entertainment content segment.

### CROSS-REFERENCE TO RELATED APPLICATION

The present application is a U.S. nonprovisional patent application of, and claims priority under 35 U.S.C. §119(e) to, U.S. provisional patent application Ser. No. 61/896,186, filed Oct. 28, 2013, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to fitness management systems, and, in particular, to systems that manage physical exercise workouts performed in conjunction with entertainment content.

2. Background

Screen entertainment is very popular, very sedentary, and very unhealthy. Sports fans, video gamers and other consumers of entertainment content may spend a lot of time watching, listening to, or playing with electronic content. Many of them also form a strong bond with their sports teams, TV, radio, podcast or gaming communities, which then may become a significant part of their lifestyles. For example, sports fans are famous for strong, almost irrational support for their favorite teams. Online video gamers have similarly strong attachments to their online gaming communities and may spend more time with their online gaming friends than they do with real-life friends.

Unfortunately, lots of time spent with entertainment content can contribute to an unhealthy lifestyle. An American football fan who watches several games per week may spend 10-15 hours in an essentially passive activity, even though the activity centers on and celebrates the fitness and athleticism of the players, who tend to be in excellent health. To make things worse, the traditional consumption of beer, pizza, snacks and other unhealthy foods before, during and after such events pushes the activity in an even unhealthier direction. Video games and TV shows may follow a similar pattern.

One way to add a fitness element to entertainment content consumption is to craft fitness “workout games” that reference events in the content as cues to perform a series of workout steps. Workout games will generally cue off plot elements or events that occur frequently in a particular entertainment genre like football broadcasts, comedy show, or first-person-shooter video games.

Although they combine fitness activities with entertainment consumption, workout games may lend themselves to solitary participation as opposed to group participation. This can be due to physical space constraints or a lack of access to participants who enjoy the same shows or games, as well as the usual scheduling and geographical issues that confront the organization of any group activity. Since group fitness workouts tend to provide more motivation than individual workouts, and lead to longer-lasting lifestyle changes, the solitary nature of current workout games can be viewed as a disadvantage. Thus, a way to integrate content workout games with a broader social community would be desirable.

At the same time, there are numerous fitness measurement devices and online services designed to encourage physical fitness activities, sometimes as part of the “quantified self” or “lifelogging” movement. These devices and their associated online communities seek to promote fitness workout activities in both individual and group settings. However, while these devices may be very useful for tracking personal activity and health metrics, after time, users may become bored with raw fitness metric data collection and stop using the devices, and their online communities.

Attempts to create online virtual fitness communities that compete or collaborate based on fitness metrics like distance, heart-rate, or cardio minutes may ultimately fail as participants lose interest in competitive or collaborative goals and rewards that are based on little more than personal data collection. For example, a fitness enthusiast might purchase an activity logger and log their steps, heart rate, or other activity levels on a daily basis. They might also upload their data to a tracking application on a web site that lets them monitor changes in their activity over time, or compare and compete with others on the site. Since the data that is collected can be somewhat sterile, it becomes difficult to build an engaging experience that captures the imagination and ongoing interest of both individuals and groups.

In addition, many fitness measurement and tracking devices are marketed to, and likely to be purchased by, users who are already involved in some kind of fitness regimen, and who are purchasing the devices to further their already existing training and fitness patterns and goals. While this is a commendable result in itself, the net benefit to such a user is significantly smaller compared with the benefit received by a passive individual in an unhealthy lifestyle who has little or no involvement in fitness activities and who is then motivated to take up a healthy lifestyle and begin pursuit of fitness and wellness goals.

In light of these challenges, a need exists for an entertainment content fitness gaming system that integrates workout games and quantified lifestyle fitness data with users' existing engagements with sports teams, video games, video, audio, and other content to help them move towards a healthier and more fit lifestyle. It also offers a way to apply personal fitness activities to shared goals in an online fitness community in a way that combines with and enhances existing fan allegiances or social communities.

### SUMMARY OF THE PRESENT INVENTION

Broadly defined, the present invention according to one aspect is a method for correlating fitness workouts to entertainment content, including: providing a workout game corresponding to entertainment content presented to a user, wherein the workout game comprises a plurality of cues, and each cue of the plurality of cues corresponds to a workout move to be performed by the user; receiving first information, the first information corresponding to an entertainment content segment viewed or otherwise consumed by the user; receiving second information, the second information corresponding to physical activity of the user while consuming the entertainment content segment; identifying, at a workout manager, a plurality of events in the entertainment content segment, wherein each event of the plurality of events corresponds to a particular cue of the plurality of cues; and correlating, at the workout manager, the plurality of cues with the second information corresponding to physical activity of the user while consuming the entertainment content segment.

In a feature of this aspect, the entertainment content segment comprises an audio or video segment from a television show, a televised sporting event, a radio broadcast, a video game, a social network hangout, or a podcast.

In another feature of this aspect, identifying the plurality of events in the entertainment content segment comprises at least one of manually identifying the events, using crowd-sourced identification of events by correlating recorded workout moves for multiple users of the entertainment content segment, or automatically identifying the events using a classifier.

In another feature of this aspect, the method further includes identifying a plurality of workout moves performed by the user using the second information corresponding to physical activity of the user while consuming the entertainment content segment. In further features, the method further includes correlating the plurality of workout moves with advertising segments in the entertainment content segment; and/or correlating the plurality of cues with the second information corresponding to physical activity of the user while consuming the entertainment content segment comprises applying an alignment algorithm that searches for the closest match between the plurality of cues and the plurality of workout moves performed by the user.

Broadly defined, the present invention according to another aspect is a system for correlating fitness workouts to entertainment content, including: at least one computer including at least one processor and at least one memory, the at least one computer configured to provide a workout game corresponding to entertainment content presented to a user, wherein the workout game comprises a plurality of cues, and each cue of the plurality of cues corresponds to a workout move to be performed by the user, receive first information, the first information corresponding to an entertainment content segment viewed or otherwise consumed by the user, receive second information, the second information corresponding to physical activity of the user while consuming the entertainment content segment, identify a plurality of events in the entertainment content segment, wherein each event of the plurality of events corresponds to a particular cue of the plurality of cues, identify a plurality of workout moves performed by the user using the second information corresponding to physical activity of the user while consuming the entertainment content segment, and associate each cue of the plurality of cues with a workout move of the plurality of workout moves.

In a feature of this aspect, the at least one computer is further configured to calculate a workout game score using at least one of a comparison of each cue of the plurality of cues with the associated workout move of the plurality of workout moves, or a workout intensity determined using the second information corresponding to physical activity of the user while consuming the entertainment content segment. In further features, the at least one computer is further configured to compute a team score using workout game scores for a plurality of users; the at least one computer is further configured to compute a first team score using workout game scores for a first plurality of users and compute a second team score using workout game scores for a second plurality of users, wherein the first plurality of users performs physical activity during a first shift and the second plurality of users performs physical activity during a second shift; the at least one computer is further configured to present an award to the user based at least on part on the workout game score; and/or the at least one computer is further configured to present a comparison of the workout game score to a previous workout game score.

In another feature of this aspect, the at least one computer is further configured to cause audio to be presented to the user to instruct the user to perform workout moves.

Broadly defined, the present invention according to another aspect is a non-transitory computer-readable medium comprising computer executable instructions that, when executed, cause one or more processors to perform actions including: providing a workout game corresponding to entertainment content presented to a user, wherein the workout game comprises a plurality of cues, and each cue of the plurality of cues corresponds to a workout move to be performed by the user; receiving first information identifying a plurality of events in an entertainment content segment viewed or otherwise consumed by the user, wherein each event of the plurality of events corresponds to a particular cue of the plurality of cues; receiving second information, the second information corresponding to physical activity of the user while consuming the entertainment content segment; and correlating the plurality of cues with the second information corresponding to physical activity of the user while consuming the entertainment content segment.

In a feature of this aspect, the second information corresponding to physical activity of the user while consuming the entertainment content segment includes heart rate information, one or more images, or one or more videos.

In another feature of this aspect, the second information corresponding to physical activity of the user while consuming the entertainment content segment includes heart rate recovery information.

In another feature of this aspect, the second information corresponding to physical activity of the user while consuming the entertainment content segment comprises manual indications provided by the user.

In another feature of this aspect, the actions further include: receiving third information, the third information corresponding to a location of the user; and using the third information corresponding to the location of the user to compute a workout game score or to determine if the user was present during presentation of an advertisement. In a further feature, the third information corresponding to a location of the user includes video or audio captured by a user device.

In another feature of this aspect, the actions further include: generating game summary information based on results of correlating the plurality of cues with the second information corresponding to physical activity of the user while consuming the entertainment content segment; and causing the game summary information to be published on a social networking website

Broadly defined, the present invention according to another aspect is a method for correlating fitness workouts to entertainment content, including: providing entertainment content and workout games that match one another; identifying cues in a particular entertainment content; recording workout moves performed by a user during a particular workout game that matches the particular entertainment content; and correlating the workout moves with the identified entertainment content cues.

In a feature of this aspect, the provided entertainment content includes an audio or video segment comprising a television show, a televised sporting event, a radio broadcast, a video game, a social network hangout, or a podcast.

In another feature of this aspect, the user selects the particular entertainment content. In a further feature, the selected entertainment content is of a particular genre, and wherein the user selects a workout game corresponding to the genre of the previously selected entertainment content.

In another feature of this aspect, content cues are identified and stored in a database. In further features, identifying content cues includes reviewing, by a human, of content, and manual recording of cue times in a log or database; identifying content cues includes crowd-sourced identification of content cue times by correlating recorded workout moves for multiple users of the same entertainment content; identifying content cues includes importing externally computed content cues from external data sources; identifying content cues includes automated generation of content cues by computationally searching the content for patterns matching the desired cues; content cues are identified as a batch before or after being used for workout games; and/or content cues are identified in real-time from dynamically generated content, such as during the playing of a video game or the broadcast of a live event.

In another feature of this aspect, the method further includes identifying and storing workout moves. In further features, the step of identifying and storing workout moves includes receiving a recorded log or real-time stream of user workout activity metrics from one or more activity tracking devices, tagging workout moves by identifying patterns of changes in the activity metrics that correspond with a workout move, and attaching timing, intensity and other event classification metadata to each workout move occurrence; and workout activity is received indirectly from the activity tracking devices, and the method further includes receiving a visual image of recorded user workout activity as logged by an activity tracking device, and extracting workout activity data points from the image using automated image processing techniques.

In another feature of this aspect, the step of correlating the workout moves with the identified entertainment content cues is done by searching for the closest match between workout moves and content cues, and the method further includes: applying an alignment algorithm which searches for the closest match between workout moves and content cues by comparing timings; identifying and tagging matching workout moves and content cues; and identifying and tagging significant timing gaps or mismatches between workout moves and content cues.

In another feature of this aspect, the step of correlating the workout moves with the identified entertainment content cues is done manually by a system user.

In another feature of this aspect, the step of correlating the workout moves with the identified entertainment content cues is performed automatically.

In another feature of this aspect, the method further comprises applying an automated matching algorithm to find the combination of workout genre, workout game, and entertainment content that best fit the recorded workout activity.

In another feature of this aspect, the method further includes a step of calculating a workout game score by computing how closely the workout moves matched the workout game as well as the overall intensity of the workout. In further features, workout game scores and performance metrics are supplied to an affiliated system; and the affiliated system is a fantasy sports league, a video gaming system, a weight loss or fitness tracking system, an athletic sporting league, or a social content system.

In another feature of this aspect, the method further includes a step of aggregating workout moves from multiple users, comprising a workout team, into a combined team workout with users trading off workout activities in shifts. In further features, workout shift changes are mapped to entertainment genre cues; and/or a plurality of workout teams are pitted against each other in competitions.

In another feature of this aspect, the method further includes calling out workout game moves, corresponding to content cues, by a workout instructor or coach located remotely from the user.

In another feature of this aspect, the method further includes correlating workout moves with advertising segments in the particular entertainment content. In further features, the method further includes a step of certifying the user's engagement with the advertising segment; and certifying the user's engagement with the advertising segment includes identifying the timing of advertising segments, and matching workout move timing with advertising segments.

In another feature of this aspect, the entertainment content is presented to the user via a content source, and the method further comprises tracking a physical location of the user relative to a physical location of the content source in order to validate when and for how long the user participated in the workout being presented on the content source. In further features, the validated user workout proximity data is used to certify the user's engagement with an advertising segment in the particular entertainment content; tracking the physical location of the user relative to the physical location of the content source is carried out using a geophysical tracking device such as GPS or a Bluetooth radio beacon; tracking the physical location of the user relative to the physical location of the content source is carried out by capturing video or audio from the content source on a smart phone which is also logging workout activity; and/or tracking the physical location of the user relative to the physical location of the content source is carried out by capturing attestations from other users that a particular user was in the workout and was engaged with the workout content.

In another feature of this aspect, the method further includes a step of automatically monitoring biofeedback from the user. In further features, the step of automatically monitoring biofeedback from the user includes monitoring the user's heart rate; the step of automatically monitoring biofeedback from the user includes monitoring the user's heart rate recovery; and/or the method further includes a step of returning shift modifications (in or out for series/quarter/etc.), intensity modifications (smaller sets), or warnings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further aspects, features, embodiments, and advantages of the present invention will become apparent from the following detailed description with reference to the drawings, wherein:

FIG. 1 is a tabular representation of an exemplary workout game design in accordance with one or more embodiments of the present invention;

FIGS. 2A and 2B collectively provide a description of a particular content segment for use in the exemplary workout game described in FIG. 1;

FIG. 3 is an example graph of recorded workout activity corresponding to the content from FIGS. 2A and 2B, in accordance with one or more embodiments of the present invention;

FIG. 4 is a data relationship diagram of an entertainment content fitness gaming system, in accordance with one or more embodiments of the present invention;

FIG. 5 is a package diagram of an entertainment content fitness gaming system in accordance with one or more embodiments of the present invention;

FIG. 6 is a sequence diagram for an entertainment content fitness gaming system, showing workout configuration steps, all in accordance with one or more embodiments of the present invention; and

FIG. 7 is a sequence diagram for an entertainment content fitness gaming system, showing workout steps, all in accordance with one or more embodiments of the present invention.

### DETAILED DESCRIPTION

As a preliminary matter, it will readily be understood by one having ordinary skill in the relevant art (“Ordinary Artisan”) that the present invention has broad utility and application. Embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is it to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

### COMMON TERMS AND CONCEPTS

Activity Trackers: An activity tracker (sometimes simply a “tracker”) may be any device or method that tracks a workout user's level of activity. Common examples may include fitness bands that measure the user's position and motion, devices that measure biometrics like heart rate, breathing rate or blood oxygen levels, cameras, devices that track speed or effort, etc. Trackers may also be implemented as manual entry systems where users enter workout activities manually, either in real time or after the fact. For example, a picture of a graph of user heart rate or some other activity metric could be processed with image recognition algorithms to locate and extract the relevant user activity metrics. Similarly, video of a user playing a workout game could be processed to extract their physical movements and then converted into activity tracking data.

Content: Content is a show, program, sporting event, video game session, movie, or other entertainment presented on or via entertainment media. Examples may include a live sporting event, a daytime TV soap opera, a video game playing session, and so forth. The content may be generated live or may have been generated previously.

Content Segment: A content segment is a particular portion of content. A content segment may be an entire show, program, event, or the like, or it may be only a portion thereof.

Cues and Events: A cue is a class or pattern of detectable data patterns that can occur during a workout, and which can be used to signal a change in workout game play, frequently involving a change in the user's activity level. Cues may occur in the entertainment content, user activity, a passage of time, or any other relevant and detectable workout data pattern. For example, a sports broadcast cue might be “after each play.” For a TV show, a cue might be “after applause.” For a video game, an example cue could be “each time your player dies.” Cues might also correspond to changes in a user's biometrics, like heart rate, movement, speed, or intensity levels. A cue could also simply be a point in time at which a change in workout intensity should occur.

An event is a specific occurrence of a cue during the workout game. So, for example, whereas a cue might be “after an interception” an event would correspond to a specific occurrence of an interception, such as “the interception thrown at 1:34 in the first quarter of the Giants at Panthers NFL game on 2013-11-17,” or a specific biometric change such as “when the user's heart rate dropped below 100 BPM at time 4:05 of the workout.” An event may also be composed of more complex data patterns. For example, the previous example events may be combined into a single event as in “when the user's heart rate dropped below 100 BPM at time 4:05 of the workout immediately following the interception thrown at 1:34 in the first quarter of the Giants at Panthers NFL game on 2013-11-17.”

Genre: a specific form of entertainment for which workout games can be constructed. For example, “NFL Broadcast,” “Hockey Game,” “Auto Racing,” “Situation Comedy,” “Crime Drama,” “First Person Shooter,” “MMORPG,” “Sports Call-in Show” or “Music Variety show” could all be genres for which workout games could be created.

Move, or workout move: a pattern of workout activity, often but not necessarily always made up of a combination of reps and sets. For example, a move could be a set of pushups, pull-ups, or lifting dumbbells. Another example would be temporarily increasing (or decreasing) speed on a treadmill, biking machine, or rowing machine. Any exercise or fitness activity that changes the level of effort can be treated as a workout move. As discussed in the workout game definition below, content genres may differ in their general flow and the types of workout moves that work well may change with the content genre. For example, continuous activities like running on a treadmill or riding a stationary bike may be better suited for genres with more continuous activity such as racing or hockey. Moves that involve specific counts of actions with a rest in between may work best with segmented content genres like football or baseball where there is time to recover between plays or pitches.

Repetition, or “rep”: the basic unit of workout activity, consisting of a repeatable exercise sequence. Several reps done in sequence can be used to form a set (below). For example, a rep could be a single weight lift, or a single jumping jack. Repetitions can also be applied to continuous activities, such as holding a yoga pose for a certain period of time, or lifting the rate on a stationary bike or running treadmill for a particular distance.

Set: a number of repetitions performed together, usually followed by a pause, rest, or other break. Sets can be further designated as “short” or “long” sets if a workout game accommodates. For example, a set could be 8 repetitions of a particular exercise. Again, the composition of a set may vary depending on content genre flow. For continuous activities, the set could simply be periods of additional exertion, or a “lift,” with the rest period comprised of a return to a steady state of lower physical (and potentially mental) exertion.

Shift: the part of a workout game during which a user is actively participating. For example, a user working out while watching an NFL football game might only perform workout moves when their teams defense or special teams are on the field, and then take a rest break while their offense is playing.

Users: one or more persons playing workout games.

Workout: a fitness activity performed while consuming entertainment content.

Workout game: a fitness game that involves performing workout moves corresponding to cues in entertainment content. Games may be tailored to the typical flow of the content genre. For example, workout games can differ depending on how the flow of the content genre is segmented. For example, in content genres like basketball, hockey, most types of racing and soccer, video games and most TV shows are generally continuous. Genres like American football, baseball and tennis or gold tend to be segmented into “plays” or other structures.

Workout team: a group of users who join together as a team to play a workout game. They may perform the workout simultaneously or trade off workout shifts based on the structure of the workout game being played. For example, “offense” vs. “defense” for a sports broadcast.

### Introduction

### Workout Games

Referring now to the drawings, in which like numerals represent like components throughout the several views, embodiments of the present invention are next described. The following description of the embodiment(s) is merely exemplary in nature and is in no way intended to limit the invention, its application, or uses.

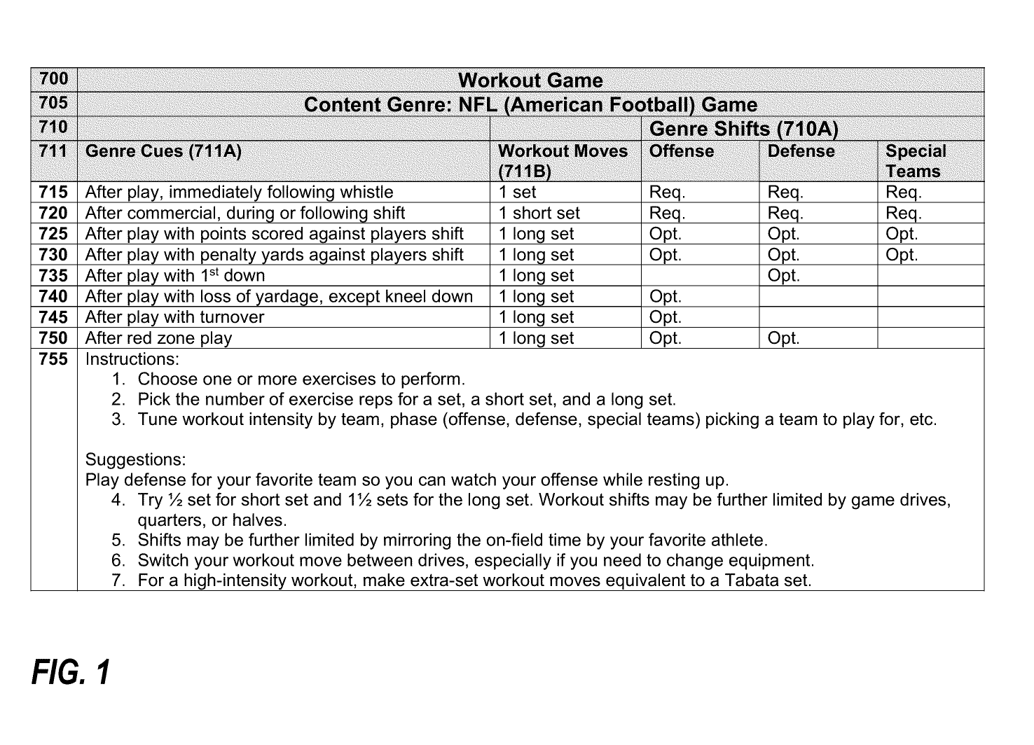

FIG. 1 is a tabular representation of an exemplary workout game design in accordance with one or more embodiments of the present invention. A workout game 700 describes workout moves that can be synchronized with entertainment content cues, allowing the user to use their entertainment content as a workout motivation tool. The game could be presented, for example, in a smart television, mobile application, web site, video game, television broadcast. It might also be delivered in more traditional forms such as a printed handout or workbook for use by workout instructors or coaches. In at least some embodiments, a particular workout game 700 is tailored or customized to a particular genre 705. For example, as indicated in the second row of the table of FIG. 1, the entertainment genre 705 may be an American football game.

Rows 710-711 are column headers for rows 715 through 750, which contain the rules for mapping content cues to workout moves. During a user's workout, when an event matching one of the genre cues 711A in the second column occurs in the entertainment content, the user is expected to perform the workout moves 711B specified in the third column. In this example, the workout game 710 specifies all of the moves as combinations of repetitions and sets but gives the user control over workout intensity by letting the user specify which exercise they will perform, as well as how many repetitions of an exercise constitute a set. In various other workout games 710, the workout moves 711B may be specified as specific workout activities, the number of reps in a set may be specified, and the like.

In at least some embodiments, the length of the workout is selected to match the length of the entertainment content itself. However, since entertainment content can be quite lengthy, a user can, in at least some embodiments, split the workout into “workout shifts” in order to take occasional breaks, to share the workout with friends, and/or to create a competition that mirrors the dynamics of the entertainment genre. In the illustrated example, the three columns under the Genre Shifts heading 710A relate to different phases of an American football game: “Offense” for when the offensive unit is on the field, “Defense” for when the defensive unit is playing, and “Special Teams” for when the special teams unit is active. An entry of “Req.” indicates that the workout move is required for this shift whenever the content cue occurs. An entry of “Opt.” indicates that the workout option is optional, allowing the user to further refine the workout intensity. Finally, in the bottom row, additional instructions and options 755 are provided for application by the user to their particular workout experience. For example, in the illustrated workout game 700, the option is offered to substitute a “Tabata” set, which is a high-intensity, short-duration set of exercise moves.

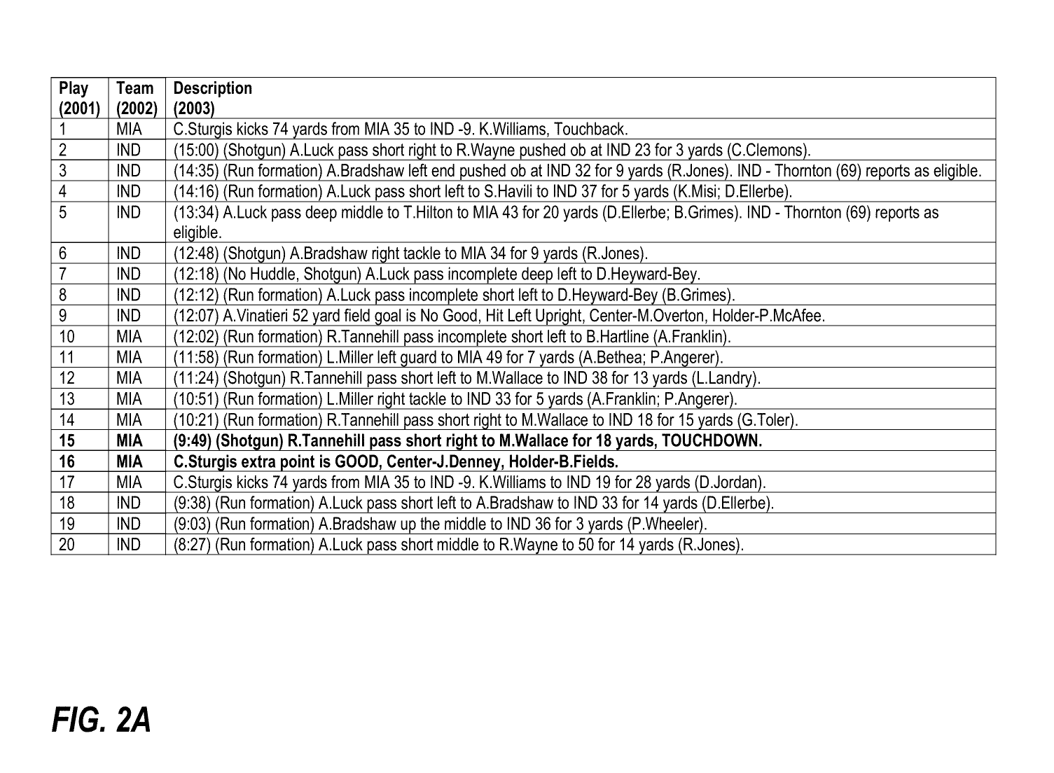

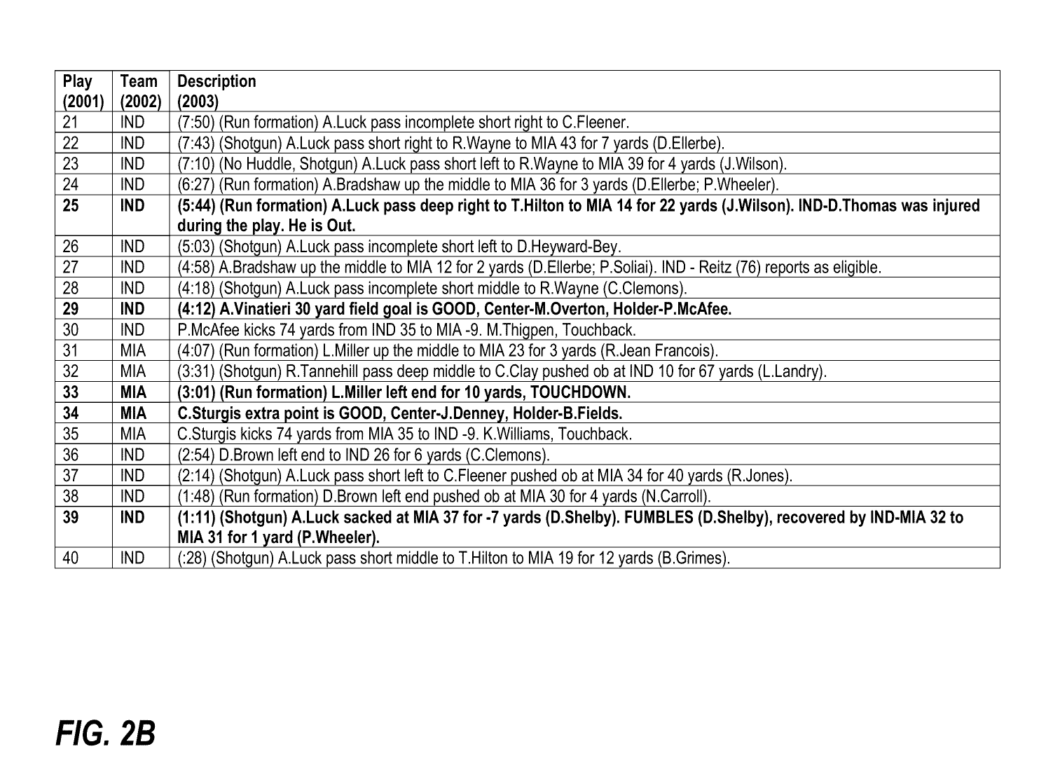

FIGS. 2A and 2B collectively provide a description of a particular content segment for use in the exemplary workout game 700 described in FIG. 1. In particular, FIGS. 2A and 2B collectively provide a listing of plays that occurred during an example American football game, with plays resulting in scoring, turnovers, or timeouts highlighted with bold text. In this example, the first quarter of a game between the Miami Dolphins and the Indianapolis Colts that was played on Sep. 15, 2013. This data will be used as an example herein to describe the process of correlating workout game moves to cues in entertainment content. In the table, the first column indicates the play number 2001, the second column indicates the offensive team 2002 at the start of the play, and the last column describes the play results 2003.

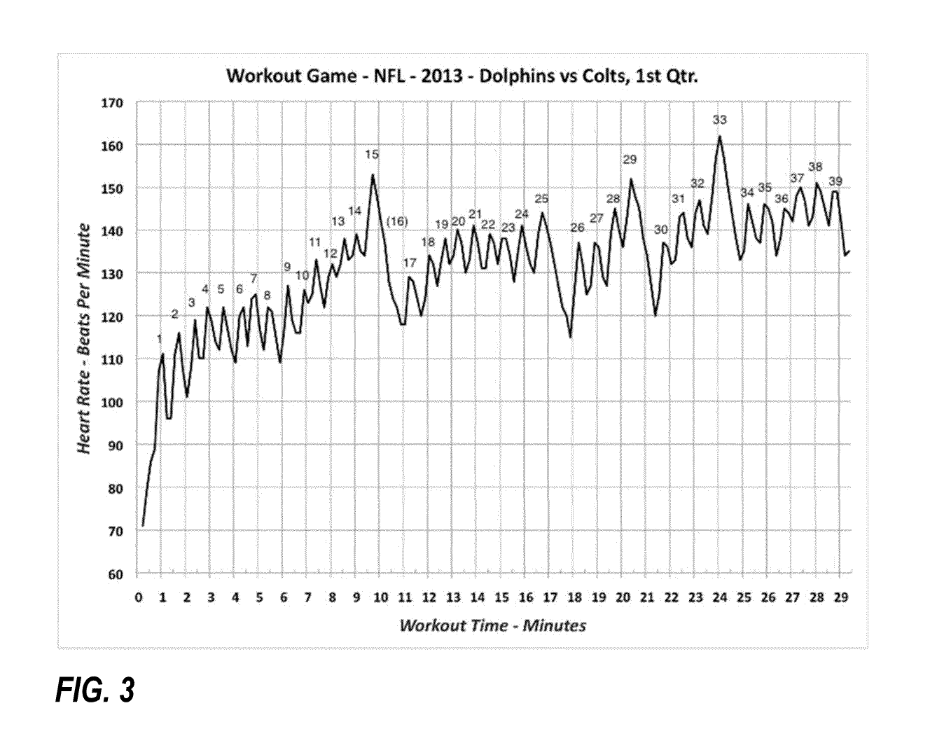

FIG. 3 is an example heart rate graph captured from a system user while playing a simplified version of the workout game described in FIG. 1. The X axis of the graph is time during the workout, which lasted approximately 30 minutes. The Y axis of the graph shows the user's heart rate in beats per minute during the workout. In addition, each peak in the heart rate graph is numbered for reference from 1 to 39 corresponding with the play number 2001 that preceded, or “caused” it, as identified in FIGS. 2A and 2B. In this simplified example, the user performed one set of 5 exercise repetitions after the completion of every play, and performed an additional repetition for each point scored following the scoring play. The user also took breaks for timeouts on the field. In addition, the game was played back from a recording on a DVR system and the user skipped most of the commercial breaks. In this example, heart rate data was collected using a heart rate monitor chest strap connected wirelessly to a data collection device.

Referring to the play-by-play descriptions from FIGS. 2A and 2B, it can be readily seen that peak events in the user's heart rate data patterns can be used as cues while playing the football workout game. Smaller peak events correspond to non-scoring play cues, and the larger peak events correspond to scoring play cues or other cues where additional workout sets were performed. For example, the first 14 smaller peak events, from roughly 1-9½ minutes on the X axis, correspond to the first 14 non-scoring plays. Plays 1-9 were an Indianapolis drive that culminated in a missed field goal for no points scored. Miami then responded with a 6-play drive that culminated in a touchdown on play 15 followed closely by a successful extra point attempt on play 16, which corresponds to a large heart rate peak event at about 9½ minutes into the workout at the peak labeled with the number 15.

By comparing the remaining heart rate peak events in FIG. 3 with the remaining plays from FIGS. 2A and 2B, it can be seen that the user played the workout game as expected. A large drop in heart rate can be seen at about 17 minutes into the workout corresponding with an injury timeout after the play, and the heart rate peak, labeled as 25. The larger peak event at about 20½ minutes corresponds with Indianapolis scoring a field goal on play (and heart rate peak) 29. Then, 4 plays later, at about 24 minutes into the workout, a large heart rate peak is seen where Miami scores a touchdown on play 33 and kicks the extra point on play 34. The remaining 6 plays of the quarter then pass with no additional scoring or other optional workout effort.

By following this example, it can be seen that correlating user activity measurements with predicted results can correlate workout games with entertainment content. Although the previous example could have been implemented by using fairly simple peak-detection algorithms, it can be appreciated that any algorithm, such as best-fit, pattern matching, or data correlation, could be applied to the data by one skilled in the art, in order to account for time or intensity mismatches in the data sets. In this way, defects, additions, and dropouts in the recorded user activity data, as well as the cue event data can be identified and repaired.

It can also be appreciated, by one skilled in the art, that numerous game performance metrics could be extracted from the resulting game to content correlation. Examples include how well the user followed the game play or how intense the user's workout was. This information could then be used as a metric for user engagement with the workout platform, allowing collaboration and competition based on how “well” each user played their workout games.

### Data Model

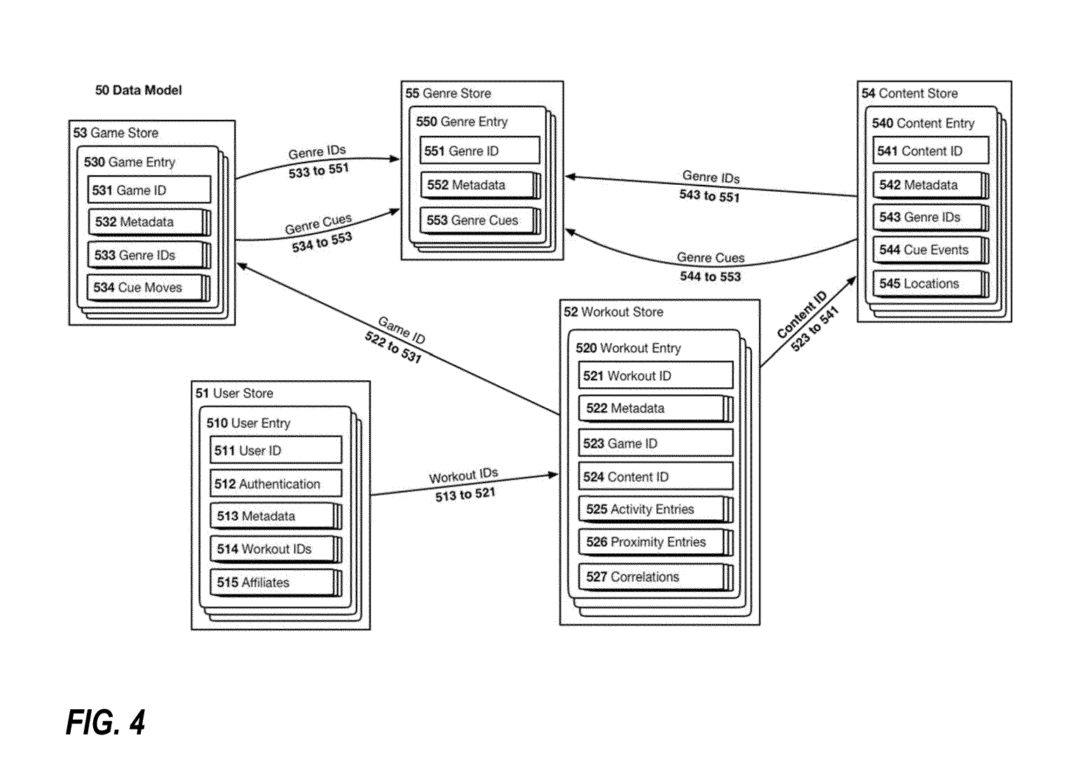

FIG. 4 is a data model 50 in accordance with one or more embodiments of the present invention. As shown therein, the data model 50 may include several data stores 51-55, typically implemented as electronic databases or object stores, each holding a set of entries 510, 520, 530, 540, 550 for a data type. Each data type entry is further divided into data fields 511, 512, 521, 523, 524, 531, 541, 551 or collections 513-515, 522, 525-527, 532-534, 542-545, 552, 553. A field indicates a single data value and is shown as a simple box. A collection indicates a field that can store multiple data values, such as an array, list, set, table, and so forth. A collection is shown as a stack of boxes.

Each data type has an “ID” field 511, 521, 531, 541, 551, which is the primary key for that data type and will always be the first field listed. Every data type also has a “Metadata” field 513, 522, 532, 542, 552 which is a compound data type containing additional data that may be used for description, filtering, searching, or other tasks. Relationships between the stores are shown as arrows, with the head of the arrow pointing towards the target of the relation, and the label text on the arrow indicating the fields that contain the key fields in the source and target data stores. The target field will often, but not always, be the ID field from the target store.

### Genre Store and Genre Cues

In order to match workout games with entertainment content, they need to be categorized. In this example implementation, the key concept of a “genre” is used to identify matching game and content. Information about genres is kept in the Genre Store 55 which keeps information about each workout genre in multiple Genre Entries 550. Examples of game and content genres include sports entertainment genres like “NFL Broadcast,” “Hockey Game,” or “Auto Racing.” Television shows could also be sorted into genres like “Situation Comedy,” “Crime Drama” and so forth. There could be video game genres like “First Person Shooter” or “MMORPG.” Audio could be divided into genres like “Sports Call-in” or “Music Variety.”

Each Genre Entry 550 has a Genre ID field 551 which uniquely identifies it as well as a Metadata field 552 containing descriptive text and additional genre categorization and selection data. However, the primary purpose for the Genre Store 55 is to list the content cues specific to the genre.

As mentioned previously in the definitions, and described in the workout game section, cues are those points where a workout user is expected to change their effort level by performing a workout move in response to the occurrence of a matching cue event, often in the accompanying entertainment content. The Genre Cues 553 collection stores all of the cues supported by the genre, as well as any data needed to manually or automatically identify cues from events that occur during content performance. Referring again to FIG. 1, the textual description of each cue under the Genre Cues 711A heading would be enough for a person to manually identify each cue. Or, the same text could be matched to a real-time feed of play-by-play announcements in order to automatically detect cues. Finally, image and audio analysis of the broadcast could be done automatically to extract the end of play whistle, text on the screen, or the broadcast announcers' or game officials' speech in order to automatically detect the relevant content cues. In the last example, the audio, video, or speech pattern events corresponding to cues would also need to be stored in the Genre Cues 553 collection.

From this description, it should be clear that any content artifact or pattern that could be described for automated or manual detection could be employed as a workout cue. It should also be clear that cues are not limited to simple data patterns, but could be compounded from multiple inter-related data patterns occurring at different times. In the FIG. 1 example, a cue could be described in terms of game clock, as well as actions occurring on the field. In addition, biometric feedback data from the user themselves or their activity monitoring devices could also be used as cues to modify activity levels.

### Workout Moves and the Game Store

Workout game definitions are kept in the Game Store 53, a data store where each game is stored as a Game Entry 530. Each Game Entry 530 has a Game ID field 531 which uniquely identifies it, as well as a Metadata field 532 containing descriptive text, notes, and additional game categorization and selection data. Since workout games are genre-specific, but might be usable with more than one genre, the Genre IDs collection 533 lists the IDs of the genres with which the game can be played, corresponding to the matching unique Genre ID 551 fields in the Genre Entries 550.

Workout moves are the heart of a workout game. The Cue Moves 534 collection lists workout moves and their corresponding Genre Cues 553, from the Genre Store 55. For example, a Genre Entry 550 in the Genre Store 55 for “NFL Game Genre” might list a cue for “After Each Play” in its Genre Cues 553 collection. In the Game Store 53 a Game Entry 530 for the “NFL Workout Game” entry would have a corresponding Cue Moves 534 item indicating the workout move “Perform One Normal Set of Repetitions” for the “After Each Play” cue.

So workout games can be quite flexible in mapping different workout moves to the various cues present in content genres. This allows for the creation of numerous fresh and engaging workouts for each type of entertainment that the user enjoys.

### The Content Store

Entertainment content provides entertainment and engagement during the user's workout. While it may be stored and played from numerous locations and devices, and could, in fact be a part of a workout game system, this example implementation only requires that the user have their own, possibly independent, access to the workout entertainment content. The goal of the Content Store 54 is, then, to catalog the content, but not necessarily store or produce the content itself.

Within the Content Store 54, data pertaining to each piece of known content is stored as a Content Entry 540. Each Content Entry 540 has the usual Content ID 541 key field, as well as the Metadata fields 542 containing descriptive text, notes, and additional content catalog data. Since entertainment content is genre-specific, but might be usable with more than one genre, the Genre IDs collection 543 lists the IDs of the genres with which the content can be used, corresponding to the matching unique Genre ID 551 fields in the Genre Entries 550.

Cue events can be identified in entertainment content, either manually or automatically. If present, these cues, corresponding to Genre Entries 550 in the Genre Store 55, are listed in the Cues 534 collection, which may list more than one set of cues if the content can be used with more than one genre of content. For example, the list of cues for an NFL football game might simply be the game clock time for each play, along with additional cues corresponding to events that occurred during that play, such as game clock at the end of the play, whether an interception was thrown, whether a touchdown, field goal, or other points were scored, and so forth.

Finally, the Content Entries 540 may contain location data for the content, such as internet URL, television or cable provider channels, or dates and times. These are listed in the Locations 545 collection and can help users or their content playback systems to access entertainment content for their workout sessions.

### The Workout Store

The Workout Store 52 holds a Workout Entry 520 for each workout game performed by a user. It has the usual Workout ID 521 unique key field, as well as Metadata fields 522 that containing descriptive text, notes, and additional content catalog data. A workout includes a workout game and entertainment content, so the Game ID 523 field records the workout game that was played, and the Content ID field 524 records the entertainment content that the user engaged during their workout.

If the user had one or more Activity Trackers 95 enabled during their workout, that data is uploaded and stored with the workout in the Activity Entries 525 collection. The data will be specific to the type of activity tracker, but would generally map changes in user activity over the duration of the workout.

Activity data can be used to correlate the user's engagement with the workout game and content, as described in more detail below. In addition, it can also be used for other purposes, depending on the specific type of data. For example, if a user wears a heart rate monitor as their activity tracking device, and if the heart rate monitor has sufficient sampling resolution, the heart rate data could be used to manually or automatically assess the user's cardiovascular health by passing it to a cardiologist for review, or by running it through an automated analysis that searches for anomalies or “scores” the user's cardiovascular health.

In some cases, it is useful to verify that the workout activity and entertainment content playback occurred in proximity. One purpose is to provide some level of confidence that the user really did participate in the workout as they claimed. If the user has activity tracking and entertainment playback devices for which proximity data is available, that data is stored in the Proximity Entries 526 collection. For example, the radio signature of a wireless tracking device registered to the user could be monitored and recorded. The user could also take occasional time and location-stamped snapshots of a content broadcast, either audio or video, on their registered smart phone and upload them during or after a workout to provided evidence that they were working out with the indicated content.

### Workout Game and Content Correlations

If workout activity, from Activity Trackers 95, is available, it can be automatically correlated with cues in the selected content. These correlations are then stored in the Correlations 527 collection. The correlations can then be broadly used to enhance the workout experience by making the raw activity data relevant to personal fitness goals and social engagement with the user's workout peers.

For example, the correlations can be used to create performance metrics for the workout that indicate how well, how accurately, or how intensely the user performed. For example, if the user was performing a continuous activity such as walking or running on a treadmill machine, or riding a stationary bike, metrics like distance or pace could be used (along with biometrics, etc.) to compute the correlated changes in intensity levels. Similarly, if a user was performing a repetition-based workout, such as lifting weights or performing calisthenics moves, performance metrics could incorporate the number of repetitions and the intensity of the workout move performed in response to each cue. These correlations can also be used to match up the user's activity with the shifts that they took during the workout. In addition to identifying personal performance relative to the workout game, tracking the user's workout shifts creates the possibility of merging workout activity from multiple users into a collaborative team workout. For example, a group of users taking turns playing offense and defense during an NFL workout game could be merged together to create a team workout with activity spanning the entire game. This team workout could then be compared with other team workouts for the same game allowing for both workout collaboration within a team and workout competition between teams. In this way fans playing for competing teams would be able to compete against fans from other teams, tapping in to their existing fan engagement and using it as a motivator to work out, and, ultimately, pursue a healthier and fitter lifestyle.

### The User Store

The User Store 51 holds a User Entry 510 for each workout game user. It has a User ID 511 key field, to identify each user uniquely, as well as Metadata fields 513 that containing additional information about each user, like location, age, gender, photo, and so on. An Authentication field 512 contains password or other authentication data needed to identify users when they log in remotely. The Workout IDs field 514 tracks all of the workouts that the user has performed. Finally, if the user is sending their workout to any external affiliated systems, the Affiliates 515 collection tracks the information needed to pass workout data to each affiliate.

### Entertainment Content Fitness Gaming System Elements

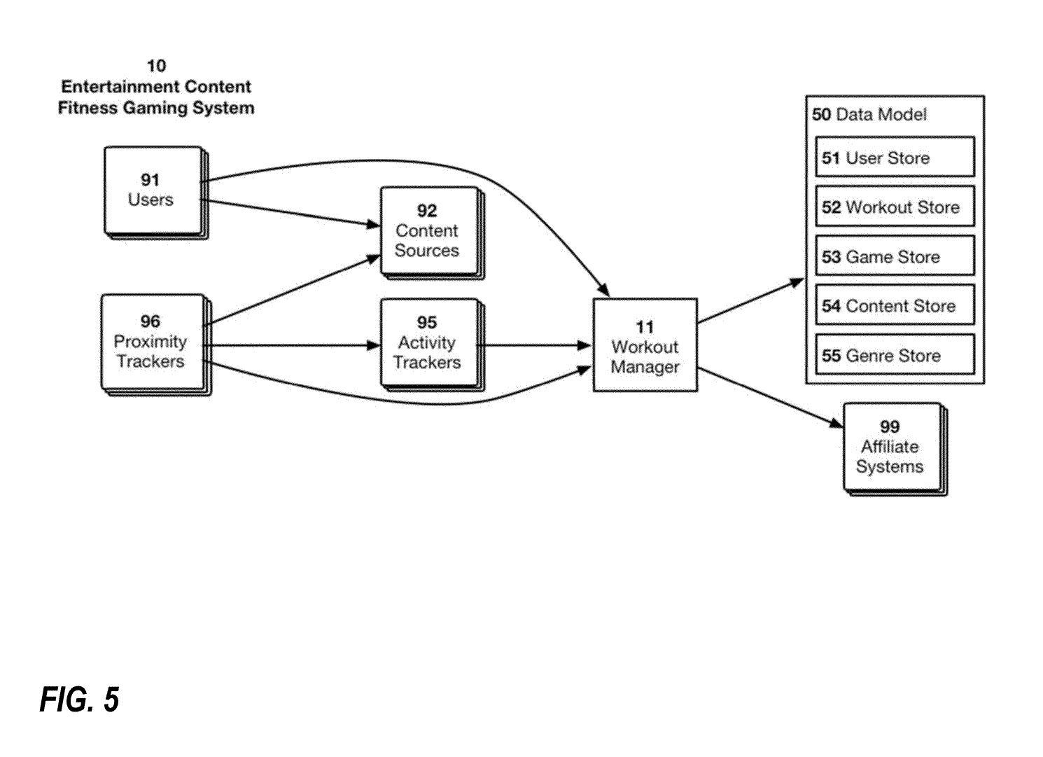

FIG. 5 is a package diagram of an Entertainment Content Fitness Gaming System 10 in accordance with one or more preferred embodiments of the present invention. As shown therein, the Entertainment Content Fitness Gaming System 10 may include:

A Workout Manager 11, which is the processing and coordination hub of the system. The Workout Manager 11 is preferably implemented as a software application system, parts of which may run on web servers as a web application, or as native applications on a laptop or desktop computer, or as native applications on a smart phone, tablet computer, or other mobile devices with remote components communicating over an electronic data communications network. An implementation of the Workout Manager 11 may be split into multiple software components, such as frontend components that interact directly with the user and backend components that perform functions that do not interact directly with the user, such as computer and communications functions.

One or more System Users 91, who use the system to manage and participate in workout games, as well as any client applications or other access mechanisms used to access the Workout Manager 11. For example, web browsers or mobile applications running on smart phones.

One or more Content Sources 92, which are used by the System Users 91 to playback entertainment content. Televisions and other video playback devices, DVRs, radios, podcast devices, and video game consoles are examples of Content Sources 92.

One or more Activity Trackers 95, which track workout activity of System Users 91. Examples include heart rate monitor belts, motion detectors like FitBit® or NikeFuel® fitness bands, smart watches like the Apple Watch, Motorola 360, or the Samsung Galaxy Gear, workout equipment that can measure speed or effort like rowing, biking, and treadmill machines, or any other device that can measure the workout effort of System Users 91.

One or more Proximity Trackers 96, which track the relative locations of Activity Trackers 95 and Content Sources 92. Outputs from the Proximity Trackers 96 can be used to validate the participation of System Users 91 in specific workouts.

One or more Affiliate Systems 99, which receive workout data for System Users 91 from the Workout Manager 11 and apply it to their platforms. Examples include fantasy football management systems, fitness tracking platforms, social networks, online gaming communities, entertainment broadcasters, sports league fan sites, insurance and health networks, corporate health programs, and so forth.

Finally, the Workout Manager 11 stores system information in several data stores, described previously in FIG. 5. The data stores are typically implemented as electronic databases or object stores.

### System Operation

### Pre-Workout Configuration

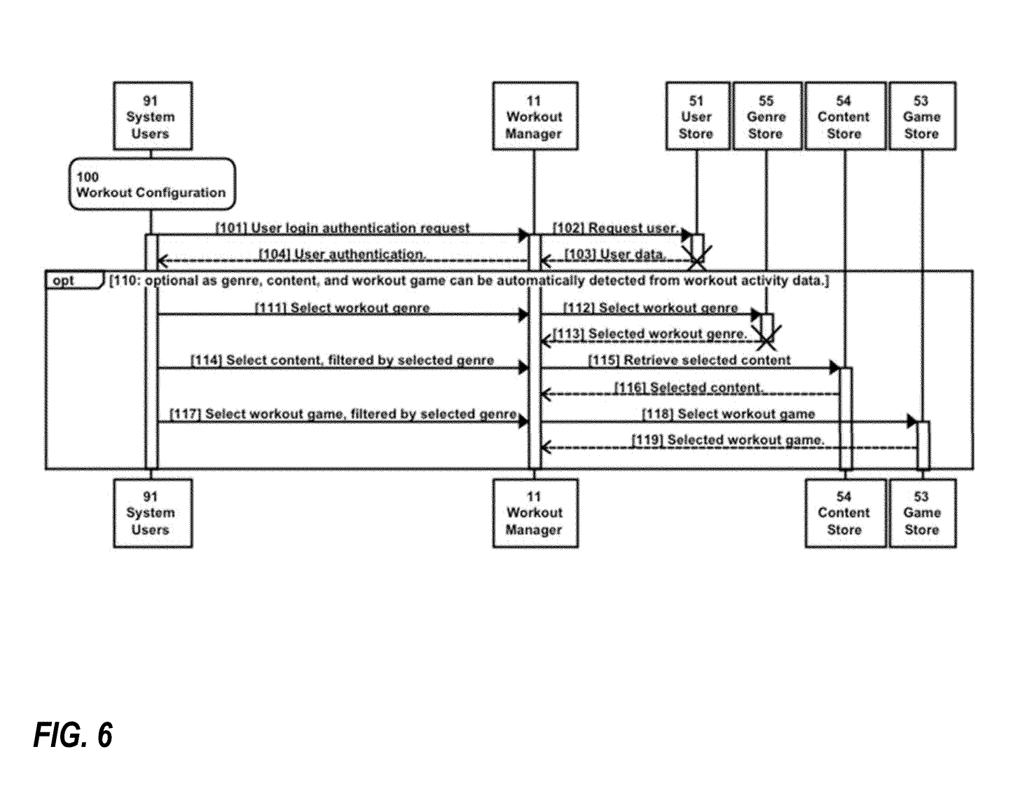

FIG. 6 is a sequence diagram for Workout Configuration 100 showing an example of the possible initial configuration steps taken by System Users 91 prior to performing a workout.

Note that all of the steps in this diagram are optional, since it is possible for a user to simply begin playing a workout game and let the system determine the game and the content they are playing with by looking for best matches of their workout moves. For example, if a user in the United States were to simply begin playing a workout game at 1 PM on a Sunday afternoon during the American football season, the system could determine that they were playing with a specific American Football game, like Washington vs. Carolina, by matching their workout move data against play-by-play cue data from the games in progress at that time. In a similar manner it would also be possible to determine finer points of the game they were playing, for example that they were playing with the Washington defensive unit. This approach could also be used when playing with recorded or otherwise archived content from past entertainment event content, again by looking for best-fit matches of user workout move data over all archived content cue data.

In any case, the user may still wish to log into and manually configure their workouts, it just doesn't have to happen before they begin playing their workout game.

In steps 101-104 the user logs into the Workout Manager 11, perhaps using a smart phone application, which sends an authentication request 101 to the Workout Manager 11 which then authenticates the user by performing a lookup 102 on the User Store 51 which returns the user's configuration data 103 to the Workout Manager 11. The Workout Manager 11 then returns authentication 104 to the user and any client application that they are using to access the Workout Manager 11.

In steps 111-119, the System Users 91 configure their workout. These steps are all placed in an optional block 110 since, as noted above, it is possible to automatically match workout activity data to a best fit combination of workout genre, content, and workout game, thus allowing the System Users 91 to proceed directly to their workout and let the system determine the configuration parameters automatically at a later time.

In the case of manual configuration, the System Users 91 select a workout genre in steps 111-113 by indicating their selection 111 to the Workout Manager 11, which looks up the genre 112 and keeps a copy of it 113 for use during and after the workout. For example, a user might select “NFL Broadcast” from a list of genres including TV shows, video games, and other sports options.

Similarly, in steps 114-116 the System Users 91 indicate to the Workout Manager 11 the workout content with which they will be exercising 114. The content choices will likely be filtered by the genre selected in steps 111-113. The Workout Manager 11 looks up the content 115 in the Content Store 54 and keeps a copy of it 116 for use during and after the workout. Note again that the Content Store 54 is only required to contain catalog information about the content, not necessarily the content itself which will typically be present on other systems, or as real-time broadcast content.

Finally, in steps 117-119 the user indicates to the Workout Manager 11 the workout game that they will be playing during their workout session 117. The workout game choices will likely also be filtered by the genre selected in steps 111-113 since workout games are typically genre-specific. The Workout Manager 11 looks up the game 118 in the Game Store 53 and keeps a copy of it 119 for use during and after the workout.

For example, the user might be using a smart phone application which presents the workout configuration options visually, allowing the user to pick the workout game they want to play and to further tailor the workout game options. Extending the example of playing with an NFL football game, the user could pick the team they wish to “play for” (home or visiting) as well as the specific units they will be “on the field” with (defense, offense, or special teams). They might also indicate those parts of the game in which they will be “playing” (working out) such as 1^{st} quarter, 2^{nd} half, etc.

This configuration approach could be generally extended to other sports. For example, for more individualized sports like auto racing content, the user might configure workout game options to match cues associated with their favorite drivers. For example, they could perform workout moves triggered by cues corresponding to race events such as completed laps by their driver, laps where their driver gains or loses positions in the racing field, or general racing events like caution periods and pit stops.

Finally, other non-sports genres could be configured similarly. For example by selecting what workout moves and set/repetition intensities to be performed when the laugh track fires while watching TV comedy content. Or, what workout moves to perform after “dying” while playing a workout game along with a first-person shooter video game.

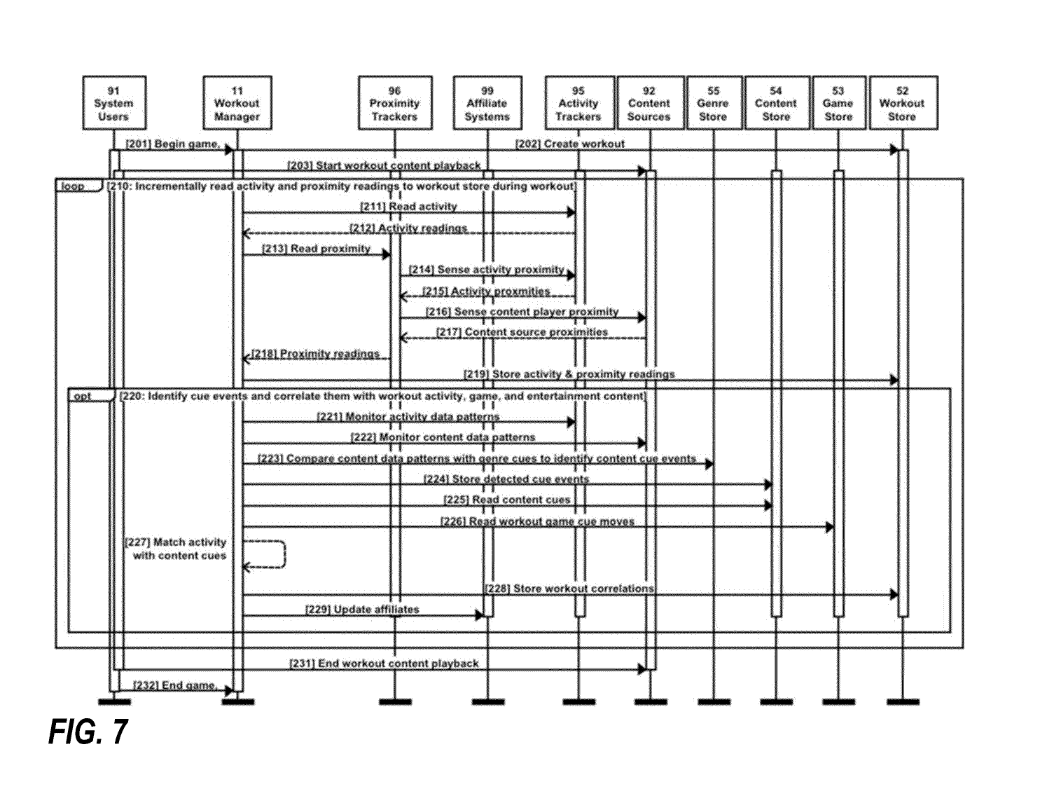

Whatever the content genre, at this point, the Workout Manager 11 has all the information it needs to facilitate a workout game and the process continues with FIG. 7 as described below.

### System Operation

### During Workout

FIG. 7 is a sequence diagram showing an example of the possible sequence of activities that take place while System Users 91 are playing a workout game. Reference will also be made to elements of the Data Model 50 from FIG. 4 as necessary.

Throughout this description, an example workout game scenario will be referenced where a user is playing a workout game while watching an American football game on their TV set. The user may have a smart phone with an application implementing an interface to control and monitor their workout. They may also be using a Bluetooth-enabled heart rate monitoring strap to track their effort levels during the workout. It is assumed that they have already configured their workout using the smart phone application per the preceding description of FIG. 6.

The smart phone application may be able to read the heart rate monitoring strap readings via Bluetooth. The application may also be connected over a network to a play-by-play data source from which it receives descriptions of each play that occurs during the football game.

Additionally, the application may also be able to record audio inputs in order to “listen” for audio matching known patterns in the TV broadcast that user has selected in order to validate that the user is in proximity to and likely is watching the TV broadcast that they have selected.

In addition, the application may also have a network connection to an audio and video feed of a remote workout instructor who will be “coaching” the workout. The instructor might be affiliated somehow with the football team that user is a fan of and has chosen to play with.

In addition, the application may also be able to display statistics and feedback for a social network of users who are playing the same workout game along with the same football game, including their team affiliations, when they will be playing (which quarters, defense, offense, etc.), and metrics related to their game playing performance. Since this is a sporting entertainment event it can be readily seen that rivalries amongst those “playing” for each team can be used as a source of workout motivation as they seek to demonstrate stronger support for their team than the competition by performing the workout.

Finally, the example smart phone application may also provide access to rewards and affiliation deals related to the workouts. In this specific example, users can either unlock fantasy football points for their fantasy teams by completing a valid workout or they can “donate” their workout to a charity or cause which will unlock third-party donations for their chosen cause, essentially letting the users perform a “Race for the Cure” without leaving their living room.

Although this example gets into specifics regarding a particular possible implementation, it is intended only to illustrate an example of one of the many possible implementations and usages of the system.

Continuing with the steps in FIG. 7, in step 201 the System Users 91 indicate that they are starting the workout to the Workout Manager 11, which creates a new Workout Entry 202 in the Workout Store 52. The System Users 91 then start their content 203 and the workout begins.

In the example scenario, the user, after bringing up the football game on their TV, might select a “begin working out” button in their smart phone application and begin watching their football game. The smart phone application would then register the user as an active user for the game and, in this example, would enable coaching audio and video activity.

At this point the user is watching the football game, perhaps checking game user stats, monitoring to the remote workout instructor, and waiting for their first workout game cue to occur.

The looping block 210 contains examples of possible steps that are repeated during the workout. In step 211 the Workout Manager 11 instructs the Activity Trackers 95 to return activity tracking data, which they do in step 212. Similarly, in step 213 the Workout Manager 11 instructs the Proximity Trackers 96 to return proximity tracking data for Activity Trackers 95 as well as Content Sources 92. The Proximity Trackers 96 query any Activity Trackers 95 and Content Sources 92 that they know about in steps 214 and 216, and receive the proximity data in steps 215 and 217, and then forward it to the Workout Manager 11 in step 218.

In the background, the example smart phone application could connect to the heart rate monitoring strap and begin watching the user's heart rate. The user's heart rate recovery may also be monitored in similar or related fashion.

The example application could also “look around” to see if the user is actually in proximity to the football game content that they selected by listening to ambient room audio and attempting to match it to expected audio for the selected TV broadcast of the football game.

The example application could also make note of the Bluetooth ID serial number of the heart rate monitoring strap and make sure that it is associated with the user playing the workout game.

Continuing with step 219 of FIG. 7, as the Workout Manager 11 collects user activity and proximity data, it stores it in the Activity Entries 525 and Proximity Entries 526 in the Workout Entry 520 entry for the workout game that is being played in the Workout Store 52.

At this point, the example application could be collecting heart rate data from the heart rate monitor and collecting and storing play-by-play data from the play-by-play data feed. It could also be relaying audio and video from the remote coach and updating game stats from the other users playing the workout.

Continuing with the description of FIG. 7 the optional block 220 contains examples of possible steps that are performed repeatedly during the workout to correlate workout game play activity with the workout entertainment content.

Although it is understood that the Cue Events 544 in the entertainment Content Store 54 may be pre-populated or supplied by an external data provider, the Workout Manager 11 may also optionally perform the task of detecting and storing the Cue Events 544 found in the entertainment content 92.

To accomplish content cue detection, in steps 221 and 222 the Workout Manager 11 may receive data streams from both the user's workout Activity Trackers 95 as well as the entertainment content source(s) 92.

In step 223 the Workout Manager 11 may search for matching patterns in the collected data streams that correspond to Genre Cues 553 from the one or more Genre Entry 550 elements from the Genre Store 55. Genre Entry 550 elements are selected which contain Genre IDs 551 matching one or more Genre IDs 543 from the Content Entry 540 in the Content Store 54 for the entertainment content source 92.

In step 224 the Workout Manager 11 may store detected Cue Events 544 to the Content Entry 540 in the Content Store 54 corresponding to the entertainment content source 92.

It should be noted that this approach is exemplary and that the Workout Manager 11 is not limited to using these two sources of data to detect content Cue Events 544, but is free to use any available data source to accomplish entertainment media cue detection.

Continuing with step 225, the Workout Manager 11 may read content Cue Events 544 for the relevant Content Entry 540 from the Content Store 54, understanding that this step is optional if the Workout Manager 11 is itself performing cue event detection per steps 221-224.

In step 226 the Workout Manager 11 may then identify expected workout Cue Moves 534, from the Game Entry 530 for the workout game that is being played, based on the Cue Events 544 that it detected or read from the entertainment Content Sources 92.

Having now determined which Cue Moves 534 the user should have attempted, in step 227 the Workout Manager 11 may compare and correlate the expected Cue Moves 534 to the user's actual workout activity stored as Activity Entries 525 in step 219.

In step 228, the Workout Manger 11 may then store the results of its correlation attempts to the Correlations 527 entries of the Workout Entry 520 in the Workout Store 52

In step 229, the Workout Manager 11 then finally updates any external Affiliate Systems 99 listed in the Affiliates 515 entry of the User Entry 510 that are monitoring the workout game.

At this point, the example application would be searching for workout game cues in the play-by-play data feed and attempting to match them to peaks in the user's heart rate, taking into account whether the user is supposed to be “on the field” playing the workout game. If real-time correlation and validation of workouts is done in this manner, it can be seen that feedback can be given to all workout game participants, either directly through their copies of the smart phone application or via third-party affiliated systems, leading to competitive motivation as the “home team” users try to defeat the “visitors” with their workout performances, and vice versa.

Continuing again with FIG. 7, after completing the workout, the System Users 91 turn off content playback in step 231 and tell the Workout Manager 11 that the workout has been completed in step 232. At this point the workout is complete.

At this point, the example scenario would conclude with parting words from the remote coaches, and perhaps a few friendly jabs at the “competition.” The resulting workout data may be logged and validated and can then be pulled up for later reference or for comparing user workout performance over time.

### System Operation

### Post-Workout

FIG. 6 and FIG. 7 contain the optional sections 110 and 220 that perform real-time, or workout-time steps. For example, in at least one embodiment, Activity Trackers 95 may not be capable of communication directly with the Workout Manager 11 during a workout. In this situation, workout data collected during optional sections 110 or 220 may be uploaded to the Workout Manager 11 in a batch operation after the workout completes. In the same way, while correlation of workout activity with the workout game can be done during the workout itself, as in optional section 220, if activity and proximity data is not transmitted during the workout, correlations will have to be done in a batch after the workout completes and workout activity data is uploaded to the Workout Manager 11.

Whether workout game validation is done during game play or afterwards, at some point an accounting or scoring is preferably made and rewards distributed for the user's workout efforts. In the example given, fantasy football league points were made available to league members who did workout games and met the standard of workout accountability. These points could be distributed on a weekly basis and used by the user as a booster to help win their fantasy league games for that week. This could act as a strong motivator for the user and is a nice complement since fantasy sports leagues often involve more screen time than simply following the local team.

The other example reward was a social good cause tie-in. By combining social good causes with fitness, the participants not only help others but help themselves as well which could additionally strengthen fitness motivation.

In addition, a social fitness platform that validates workouts opens the door to both collaborative and competitive social fitness workout groups. Although the example application had fans of football teams forming their own teams to defeat the fans of the opposing team, it can be seen that any social grouping can be used to create workout groups based on geography, sport, entertainment media genre, workout type (CrossFit, Zumba, etc.) and so forth. Following any workout, users can update and be updated by their workout teammates or competitors, knowing that they can trust the validated workout results.

Given the availability of rich, validated workout results, aggregations of user workout activity can be scored and compared amongst various social groups. For example, as mentioned previously, fans of particular sports teams could compete against each other individually or as teams based on how well they perform while playing workout games while viewing entertainment content of live sporting events, where their respective teams are vying against each other in reality. Additionally, fans for a particular team could trade off or alternate shifts during the entertainment content event. Referring again to the American football example, some fans might work out during different quarters or timing periods of the game. Other fans might only play for particular team units, such as Offense, Defense, or Special teams. In this way working out while watching the game could become a collaborative experience where fans of a particular team support each other throughout the game, acting as their own fitness motivators.

After a workout has completed, the user's workout activity and results may also trigger updates to various Affiliate Systems 99. For example, it may be advantageous for the advertising sponsors of the entertainment content source 92 to quantify the workout game users' engagement with their sponsored content during the workout game. This becomes possible given that the workout game users' activity levels and proximity to the entertainment content has been captured during steps 211-219 allowing entertainment content sponsors to validate workout game user engagement with their advertising content.

Another possible post-workout activity is the computation of crowd-sourced identification of content cue events. If there is no external or locally computed source for content event cue data, an approach that can be taken is to aggregate the collective activity of multiple workout game players who are playing with the same entertainment content, and classify their activity tracking data in order to approximate and extract cue events for the source entertainment content. Given enough users, the Workout Manager 11 can combine information about the workout game and shifts that each user is playing with their resulting activity and thereby deduce the event cues and their timing within the entertainment content. For example, if an American football workout game specifies a certain amount of additional effort after an interception on the part of users playing with the offensive unit, the Workout Manger 11 will have the ability to classify and match changes in user activity levels with activity data from previously played and validated game content of the same American football genre.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A method for correlating fitness workouts to entertainment content, comprising:
providing a workout game corresponding to entertainment content presented to a user, wherein the workout game comprises a plurality of cues, and each cue of the plurality of cues corresponds to a workout move to be performed by the user;
receiving first information, the first information corresponding to an entertainment content segment viewed or otherwise consumed by the user;
receiving second information, the second information corresponding to physical activity of the user while consuming the entertainment content segment;
identifying, at a workout manager, a plurality of events in the entertainment content segment, wherein each event of the plurality of events corresponds to a particular cue of the plurality of cues; and
correlating, at the workout manager, the plurality of cues with the second information corresponding to physical activity of the user while consuming the entertainment content segment.

2. The method of claim 1, wherein the entertainment content segment comprises an audio or video segment from a television show, a televised sporting event, a radio broadcast, a video game, a social network hangout, or a podcast.

3. The method of claim 1, wherein identifying the plurality of events in the entertainment content segment comprises at least one of manually identifying the events, using crowd-sourced identification of events by correlating recorded workout moves for multiple users of the entertainment content segment, or automatically identifying the events using a classifier.

4. The method of claim 1, further comprising identifying a plurality of workout moves performed by the user using the second information corresponding to physical activity of the user while consuming the entertainment content segment.

5. The method of claim 4, further comprising correlating the plurality of workout moves with advertising segments in the entertainment content segment.

6. The method of claim 4, wherein correlating the plurality of cues with the second information corresponding to physical activity of the user while consuming the entertainment content segment comprises applying an alignment algorithm that searches for the closest match between the plurality of cues and the plurality of workout moves performed by the user.

7. A system for correlating fitness workouts to entertainment content, comprising:
at least one computer including at least one processor and at least one memory, the at least one computer configured to:
provide a workout game corresponding to entertainment content presented to a user, wherein the workout game comprises a plurality of cues, and each cue of the plurality of cues corresponds to a workout move to be performed by the user,
receive first information, the first information corresponding to an entertainment content segment viewed or otherwise consumed by the user,
receive second information, the second information corresponding to physical activity of the user while consuming the entertainment content segment,
identify a plurality of events in the entertainment content segment, wherein each event of the plurality of events corresponds to a particular cue of the plurality of cues,
identify a plurality of workout moves performed by the user using the second information corresponding to physical activity of the user while consuming the entertainment content segment, and
associate each cue of the plurality of cues with a workout move of the plurality of workout moves.

8. The system of claim 7, wherein the at least one computer is further configured to calculate a workout game score using at least one of a comparison of each cue of the plurality of cues with the associated workout move of the plurality of workout moves, or a workout intensity determined using the second information corresponding to physical activity of the user while consuming the entertainment content segment.

9. The system of claim 8, wherein the at least one computer is further configured to compute a team score using workout game scores for a plurality of users.

10. The system of claim 8, wherein the at least one computer is further configured to compute a first team score using workout game scores for a first plurality of users and compute a second team score using workout game scores for a second plurality of users, wherein the first plurality of users performs physical activity during a first shift and the second plurality of users performs physical activity during a second shift.

11. The system of claim 8, wherein the at least one computer is further configured to present an award to the user based at least on part on the workout game score.

12. The system of claim 8, wherein the at least one computer is further configured to present a comparison of the workout game score to a previous workout game score.

13. The system of claim 7, wherein the at least one computer is further configured to cause audio to be presented to the user to instruct the user to perform workout moves.

14. A non-transitory computer-readable medium comprising computer executable instructions that, when executed, cause one or more processors to perform actions comprising:
providing a workout game corresponding to entertainment content presented to a user, wherein the workout game comprises a plurality of cues, and each cue of the plurality of cues corresponds to a workout move to be performed by the user;
receiving first information identifying a plurality of events in an entertainment content segment viewed or otherwise consumed by the user, wherein each event of the plurality of events corresponds to a particular cue of the plurality of cues;
receiving second information, the second information corresponding to physical activity of the user while consuming the entertainment content segment; and
correlating the plurality of cues with the second information corresponding to physical activity of the user while consuming the entertainment content segment.

15. The non-transitory computer-readable medium of claim 14, wherein the second information corresponding to physical activity of the user while consuming the entertainment content segment comprises heart rate information, one or more images, or one or more videos.

16. The non-transitory computer-readable medium of claim 14, wherein the second information corresponding to physical activity of the user while consuming the entertainment content segment comprises heart rate recovery information.

17. The non-transitory computer-readable medium of claim 14, wherein the second information corresponding to physical activity of the user while consuming the entertainment content segment comprises manual indications provided by the user.

18. The non-transitory computer-readable medium of claim 14, wherein the actions further comprise:
receiving third information, the third information corresponding to a location of the user; and
using the third information corresponding to the location of the user to compute a workout game score or to determine if the user was present during presentation of an advertisement.

19. The non-transitory computer-readable medium of claim 18, wherein the third information corresponding to a location of the user includes video or audio captured by a user device.

20. The non-transitory computer-readable medium of claim 14, wherein the actions further comprise:
generating game summary information based on results of correlating the plurality of cues with the second information corresponding to physical activity of the user while consuming the entertainment content segment; and
causing the game summary information to be published on a social networking website.
